(19) United States
(12) Patent Application Publication
(10) Pub. No.: US 2002/0072921 A1
(43) Pub. Date: Jun. 13, 2002

(54) Interaction-based servicing of business customers

(76) Inventors: Vernon Keith Boland, Lexington, SC (US); Kathy Dean, Georgetown, TX (US); Ronald A. Rush JR., Columbia, SC (US); Robert N. Josephson II, Richmond, VA (US); Dennis A. Parker, Columbia, SC (US)

Correspondence Address: JAMES M. STOVER, NCR CORPORATION, 1700 SOUTH PATTERSON BLVD, WHQ4, DAYTON, OH, 45479, US

(21) Appl. No.: 09/735,835

(22) Filed: Dec. 13, 2000

(51) Int. Cl. G06F 7/00; G06F 17/30; G06F 17/60

(52) U.S. Cl. 705/1; 705/7; 707/3

(57) ABSTRACT

Establishment of the context of a customer's present and future interaction with a business regardless of the interaction channel used, is facilitated by use of an interaction history database. The interaction history database stores data regarding past customer interactions. The business accesses and sorts interaction information from the interaction history database related to a customer when that customer initiates a new interaction with the business. The interaction history database may also be accessible by the customer for self service applications. The customer may access the presentation of their interaction history in an “actionable” manner. In one instance, context of an Internet user's query to a business regarding an Internet site of the business visited by the user, is conveyed to the business via data (i.e. text) automatically inserted into an e-mail after selection of an e-mail link from the business Internet site. The inserted data includes user identification information and recent web history information.

### FIELD OF THE INVENTION

The present invention relates to business practices and, more particularly, to a system and method for providing interaction based servicing of business customers.

### DESCRIPTION OF THE PRIOR ART

Customers and businesses interact with each other in a variety of manners and/or ways. Each such manner and/or way may be deemed an interaction channel. Examples of interaction channels include the Internet, the telephone, e-mail, in-store visits, exposure to advertisements, and the like.

Every time a customer interacts with a business, there is typically a period of time whereby both parties must understand the context of the interaction. This concept may be understood with the aid of the following examples. Suppose a customer calls a business with a question about a bill from the business. There is a period of time where the customer must explain to an agent of the business which bill is in question. The business agent must first understand which bill is in question. Thereafter, the bill must be located and the customer concern ascertained.

Again, suppose a customer has recently purchased a product that must be assembled. If the customer has a problem with assembly or a question about the product, he/she must go through considerable effort to enable the business to understand the context of the question. When the customer is not initially speaking with a business agent, but must push buttons for an automated voice-activated response system to identify the product recently purchased, the effort expended may not be worth the time. If the customer is trying to access the business via the Internet, the customer may need to execute various searches to obtain information regarding the recently purchased product.

Still, consider a customer who has recently utilized an ATM or kiosk owned or operated by a particular business. The customer may experience a problem with the ATM or kiosk such as a failure to provide a receipt. Because of the nature of an ATM or kiosk, the customer must go through considerable effort to explain the context of the problem to a business agent. Further, the customer may even have to interact with numerous people before connecting with a person who can address the problem.

Further, suppose the customer is interacting with a company through the company's web site. The customer may have a question about the web site or use thereof and thus send an e-mail to the company regarding the same. The customer service agent handling the e-mail question from the customer may miss the best answer for the customer in the current context because of limited information about the customer and/or the customer's web session history. The customer, in an attempt to give complete information, also spends time describing the context surrounding the question being asked in the e-mail. The lack of an accurate representation of the question context typically leads to an inappropriate answer and potentially protracted e-mail dialog between the customer and the company before arriving at the correct answer.

It is therefore desirable to have a consistent means by which a business may establish the context of a customer's question.

### SUMMARY OF THE INVENTION

The present invention provides a system and method for establishing context of a consumer/business interaction, especially during a current interaction or interaction attempt.

In one form, the present invention is a method of establishing a context of an interaction between a consumer and a business. The method includes the steps of:

(a) storing historical interaction data between a consumer and a business, the historical interaction data regarding interactions between the business and the consumer;

(b) receiving a communication from the consumer;

(c) accessing historical interaction data regarding the consumer; and

(d) processing the historical interaction data regarding the consumer in view of the received communication from the consumer to establish a context of the received communication from the consumer.

In another form, the present invention is a method of interaction between a business and a consumer. The method includes the steps of:

(a) maintaining a database of past interaction data from previous consumer to business interactions;

(b) receiving an interaction initiation from a consumer;

(c) accessing past interaction data regarding the consumer from the database of past interaction data;

(d) processing selective past interaction data regarding the consumer in view of the interaction initiation; and;

(e) establishing a context of the interaction initiation based on the processed past interaction data regarding the consumer and the interaction initiation.

In yet another form, the present invention is a method of establishing context of an e-mail from a consumer to a business regarding an Internet site of the business. The method includes the steps of:

(a) receiving an e-mail originating from an Internet terminal of a consumer, the e-mail having consumer identification data and consumer Internet session history data regarding an Internet site of the business;

(b) accessing stored historical interaction data regarding the consumer based on the customer identification data;

(c) reviewing the customer Internet session history data; and

(d) determining a context in which to present a response to the e-mail based on the customer identification data, the customer Internet session history data, and the e-mail.

In a further form, the present invention is an apparatus for establishing a context of an interaction between a consumer and a business. The apparatus includes a data storage adapted to retain historical consumer to business interaction data regarding a consumer. Means are provided for receiving a communication from the consumer. The apparatus also includes a processing unit adapted to i) access the historical interaction data regarding the consumer upon receipt of the communication from the consumer, and ii) process selective historical interaction data regarding the consumer in view of the received communication from the consumer to establish a context of the received communication from the consumer.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a block diagram representing a general form of a manner in which a consumer and a business interact;

FIG. 2 is a diagrammatic depiction of an expansion of the block representation of FIG. 1 showing various modes of customer/business interaction and a business system for establishing context of the customer/business interaction;

FIG. 3 is a flowchart of a method for establishing context of a consumer interaction with a business in accordance with the principles presented herein;

FIG. 4 is a block diagram representing a particular consumer/business access channel and interaction;

FIG. 5 is a block diagram representation of the Internet terminal of FIG. 4;

FIG. 6 is a flowchart of commencement of a consumer to business interaction by the consumer with regard to FIG. 4 in accordance with the principles presented herein; and

FIG. 7 is a flowchart of a business response to the consumer to business interaction of FIG. 6 in accordance with the principles presented herein.

Corresponding reference characters indicate corresponding parts throughout the several views.

### DETAILED DESCRIPTION

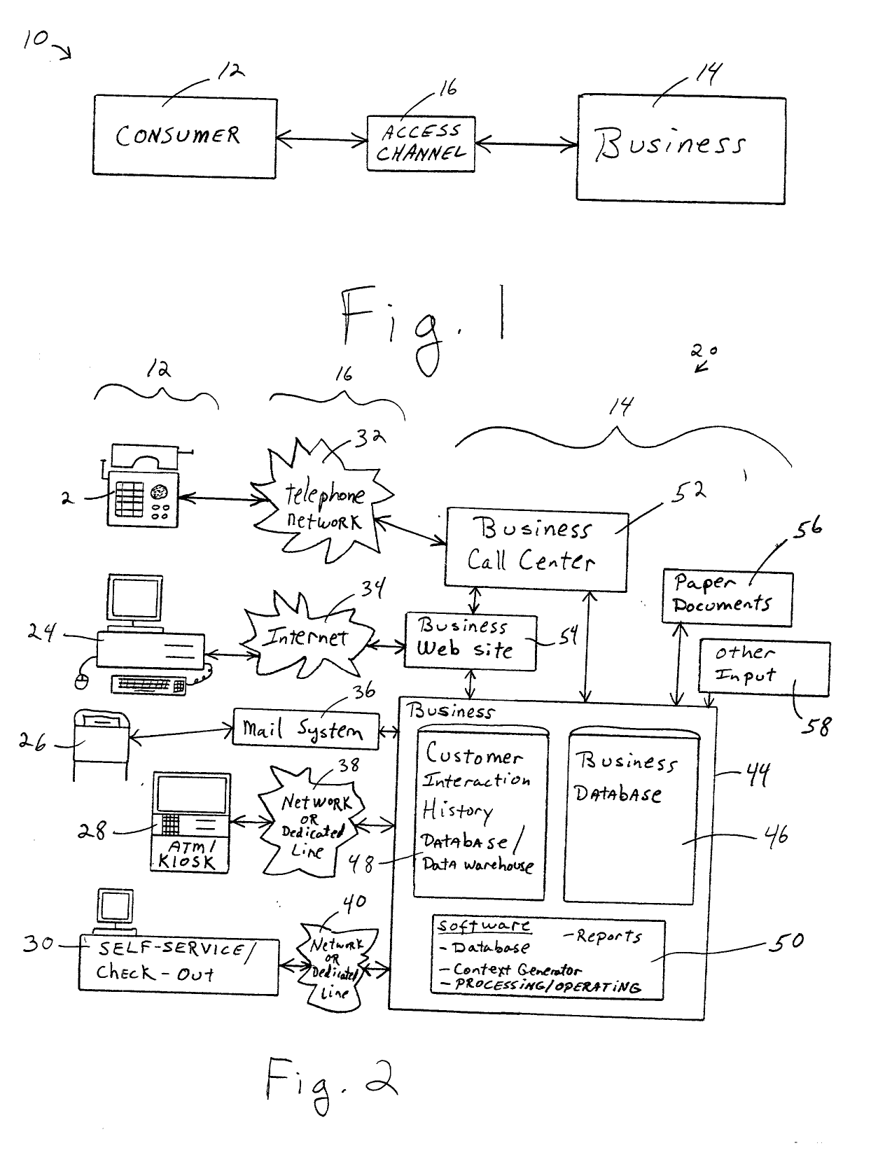

Referring to FIG. 1, there is depicted a block diagram generally designated 10 representing a generic form of the manner in which a consumer and a business interact. Interaction is defined as contact (attempted or accomplished) or correspondence by one party (the consumer or business) with the other party. The consumer 12 interacts with a business 14 via an access or interaction channel 16 for a variety of reasons. In the same manner, the business 14 interacts with the consumer 12 via an access channel 16 for a variety of reasons. It should be appreciated that the access channel block 16 of FIG. 1 represents a plurality of ways or modes of interaction between a consumer and a business. Without being exhaustive, the following are exemplary access channels (modes or ways of interaction) for interaction between a consumer and a business: via nail, via an electronic network (e.g. Internet), via a telephone (i.e. voice), and in person.

In accordance with an aspect of the present invention, the business 14 collects and/or stores information or data relating to each consumer/business interaction. The data pertains to every aspect of the interaction and may be termed interaction data. The interaction data typically includes customer data, customer account data, mode of interaction data, reason for interaction data, and other types and/or categories of data pertaining to the consumer/business contact or interaction. The collected and stored interaction data becomes historical interaction data. The historical interaction data is used to form a basis by which the business can determine or establish a context of a present consumer/business interaction in order to facilitate the mutual interaction in accordance with the principles presented herein. The historical interaction data may also be used to generate predictive data for a future consumer/business interaction, especially when the interaction is business initiated rather than consumer initiated. The predictive data may be stored as well.

At least some of the interaction data is preferably collected automatically from the various devices. This may include having the consumer give or enter information that is transmitted to and received by the business. Various methods are known to request and obtain such interaction data. In some instances, the data may be manually input by operators or agents of the business.

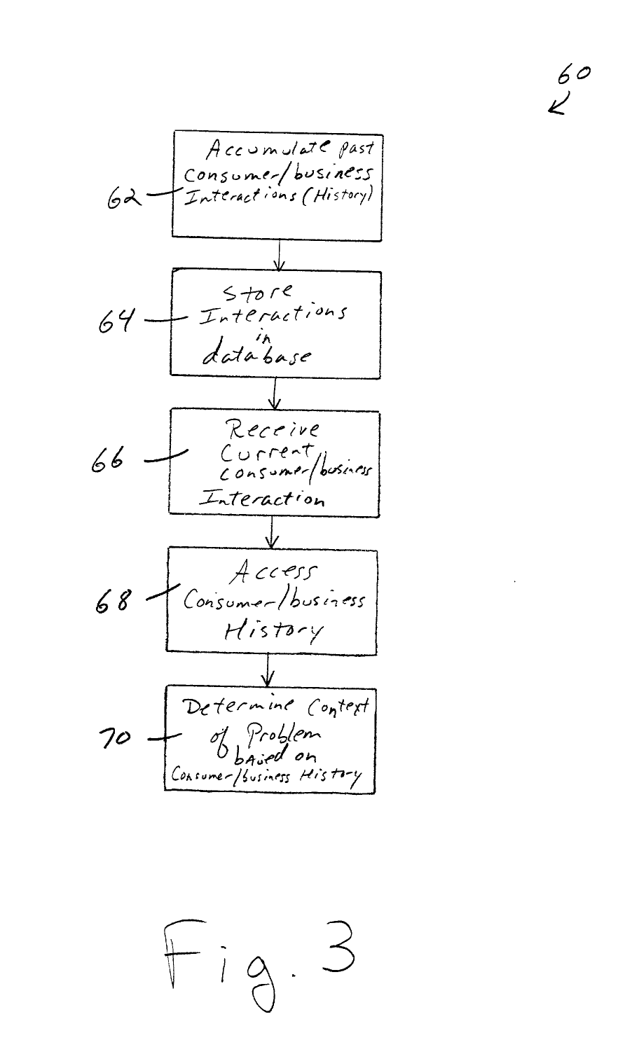

In FIG. 2, the generic form of the manner in which a consumer interacts with a business and/or a business interacts with a consumer as depicted in FIG. 1 is expanded to show specific exemplary modes of interaction. In general, the business 14 is equipped to receive a communication from the consumer 12 via at least one of the various access or interaction channels 16 and, preferably, the business 14 is equipped to receive a communication from the consumer 12 via any one, all, or a subset of all of the access or interaction channels 16 shown and those not shown, from the consumer 12. The consumer 12 is able to receive a communication from the business 14 as well, via at least one of the access or interaction channels 16. In many cases, the consumer 12 is able to receive a communication from the business 14 via several of the access or interaction channels 16. Typically, however, the consumer and business are connected during the interaction via the same interaction channel and/or type of interaction device. The communication received by the business 14 from the consumer 12 may be for any reason such as a complaint, a return of a warranty/registration card, a question of any topic, a payment on a bill, an order, an equipment problem, and/or the like. As well, the communication received by the consumer 12 from the business 14 may be in response to a previous communication from the consumer 12 or the communication may be initiated by the business 14.

In particular, an overall system, generally designated 20, is shown in FIG. 2 representing the business 14, the consumer 12 (represented by various interaction devices), and various forms of interaction/access channels 16 that may be used by the consumer 12 and the business 14 to interact with each other. The consumer 12 of FIG. 1 is particularly represented in FIG. 2 by the type of device or means utilized by the consumer to access or interact with (interaction device) the business 14. The business 14 may use any access channel 16 to interact with the consumer 12. Without being exhaustive, this includes a telephone 22, a computer or PC 24, a mailbox or postal service 26, an ATM or kiosk 28, and a self-serve check-out 30. The access or interaction channel 16 associated with each interaction device (i.e. consumer 12) is also shown.

The telephone 22 is in communication with and utilizes a telephone network 32, of any type, to gain access to a call center 52 of the business 14 (or, in general, the business 14). The telephone access/interaction channel 32 provides a live and relatively immediate means of interaction between the consumer 12 and the business 14. The business call center 52 may have only live agents that respond to the consumer and obtain interaction data, may have an automated system for obtaining interaction data, or may be a combination of live and automatic. It should be appreciated that the call center 52, at least in part, functions in a manner typical for call centers with respect to receiving calls from a consumer and/or placing calls to a consumer. In addition to these typical functions, the call center 52 obtains interaction data. The interaction data is forwarded to the customer interaction database 48 for storage and processing.

The computer 24, via a modem (internal to the computer 24 and thus not explicitly shown) is in communication with and utilizes an electronic network (e.g. the Internet) to gain access to a web site or Internet site 54 of the business 14. While not shown, the computer 24 may access the Internet 34 via an Internet service Provider (ISP) as is known in the art. The electronic network access/interaction channel 34 provides the ability to send e-mail or electronic documents and text between the consumer 12 and the business 14.

The computer 24 may thus access the web site 54 of the business to view/interact with the web site and/or send and receive e-mail to and from the business. The web site 54 thus obtains interaction data regarding the consumer 12 and the consumer's interaction with the web site 54. Data from e-mails received from the consumer and sent by the business are maintained in the customer interaction history database 48.

The mailbox 26 represents the United States Postal Service and other private (non-government) mail or package courier services, that receives mail (letters/packages) that are delivered to the business 14 via a mail delivery system 36 (access/interaction channel 16) and vice versa. In the case of mail, interaction data pertaining to a piece of correspondence must be inputted into the customer interaction history database 48. This includes data pertaining to both the consumer and the business.

The ATM/kiosk 28 is in communication with and utilizes an electronic network or dedicated line 38 for access to the business 14 and vice versa. The business 14 may monitor the action(s) being performed on the ATM/kiosk 28 via the network 38 and thus obtain interaction data from the ATM/kiosk 28. In the case of an ATM, the ATM 28 may send interaction data regarding what the consumer is doing to the business 44 for storage in the consumer interaction history database 48. Diagnostics may be performed on the ATM 28 via the network 38 based on ATM information received by the business 44. In the case of a kiosk 28, the kiosk typically allows a greater level of interaction than an ATM. However, interaction data is still received by the business 44 and stored in the consumer interaction database 48.

The self-service check-out 30 is in communication with and utilizes a network or dedicated line 40 for access to the business 14 and vice versa. Again, in like manner to the above interaction devices and access channels, interaction data is received by the self-service check-out 30 is transmitted to the consumer interaction history database 48 of the business 44 via the network 40. In addition to receiving interaction data from a consumer via the self-service check-out, the business 14 may provide information to the self-service check-out 30.

The business 14 is also operable to accept various paper documents 56, in addition to those received by the mail system 36, as a consumer/business interaction. Other input 58 is also accepted by the business 14 as it relates to consumer/business interaction data. Other input 58 encompasses all other types of data relating to a consumer/business interaction.

The business 14 includes a processing unit or center 44 that includes appropriate logic and/or circuitry, and rules or instructions (i.e. software) 50 to regulate, execute and perform processing of received interaction data, including a processing unit (processor). As well, the business 44 may provide information or data to the self-service check-out 30 during the consumer interaction. The processing unit 44 may include a general business database 46 or the like maintained in a suitable storage medium and the customer/consumer interaction history database or data warehouse 48 or the like also maintained in a suitable storage medium. The storage mediums for the business database 46 and the customer interaction history database 48 may be the same or separate. Various types of software and/or rules 50, such as database software, context generator software, processing and operating software, report generator software, and the like are also stored via appropriate storage in the processing unit 44. The processing unit 44 and associated software are operable to receive the interaction data, store the interaction data, and provide various reports regarding the historical (stored) interaction data, compilations of the historical interaction data, context generation based on the historical interaction data and a current consumer/business interaction.

The business database 46 is operable to store general business data and business data as it relates to particular customers or consumers such as bills, payments on bills, account balance, and other data that is generated by the business 14. The customer interaction history database 48 is operable to store data that relates to a customer's interaction with the business and data that relates to the interaction between the business and the consumer. As indicated above, these two databases may be separate or one, both as to physical storage and as to databases. In one sense, the customer interaction history database 48 is a data warehouse for interaction data. Interaction information or data is obtained from preferably every interaction between the consumer and the business and the business and the consumer. An interaction may be defined as one-way communication (e.g. the consumer leaves a message with the business or sends something to the business; the business leaves a message with the consumer or sends something to the consumer) or may be a two-way communication (e.g. a telephone conversation).

The business 14 also includes a business call center 52 and a business web or Internet site 54 each of which is in communication with the business processing unit 44. The business call center 52 represents at least one customer service agent for the business 14 and, more typically, represents a plurality of customer service agents for the business 14. Each customer service agent (CSA) may be either an automated answering or voice-mail type device, or a live person. The CSA is thus “operable” to receive telephone calls from the consumer (represented by the telephone 22) via the telephone network 32.

In accordance with an aspect of the present invention, each time a consumer 12 interacts with the business 14 and/or the business 14 interacts with the consumer 12, information or data regarding the particulars of the interaction is obtained by the business 14. The business processing unit 44 mines the interaction data from the interaction and stores the interaction data in the interaction history database 48. The mined interaction data then becomes historical interaction data. The extent of interaction data obtained by the business 44 and stored in the interaction history database 48 may be any type of data and, preferably, is all types of data regarding the consumer, the mode of interaction, the communication itself, the duration of the interaction, whether a problem was raised and/or solved, and the like. The historical interaction data is accessed by the business when

In particular, the consumer 12 may use the telephone 22 to contact the business 14. The telephone 22 thus connects with the call center 52. Interaction data is stored in the customer interaction history database 48 regarding the interaction. Each time a business utilizes the telephone network 32 to contact a consumer 12, data is stored in the customer interaction history database 48 regarding the interaction. Various information or data resulting from each consumer/business interaction via the telephone 22, telephone network 32, and business call center 52 is input to and stored in the customer interaction history database/data warehouse 48. Typical data, without being exhaustive, includes customer name, address, identification number/identifier, reason for the telephone call, etc.

The consumer 12 may also interact with the business 14 through use of the computer 24 to make contact with the business web site 54 via the Internet 34. The business web site 54 also provides data to the customer interaction history database 48 regarding the interaction. In addition to contact with the business 14 via the web site 54, the consumer 12 may utilize the computer 24 to send e-mail to the business 14. Data pertaining to the e-mail is also provided to the interaction history database 48. As well, data from an e-mail sent by the business to the computer 24 (i.e. the consumer 12) via the Internet 34 is data for storage in the interaction history database 48.

The consumer 12 may also interact with the business 14 by using the mail service (represented by the mailbox 26) via the mail system 36. Letters, bill payments, etc. and other documents that are received by the business 14, are input to the customer interaction history database 48. Paper documents promulgated by the business 14 are also input into the interaction history database 48.

The consumer 12 may also interact with the business 14 via an ATM or kiosk 28. The interaction between the consumer 12 and the business 14 with regard to the ATM/kiosk may occur in the background of the transaction and not immediately apparent to the consumer 12. Stated another way, the consumer is typically not cognizant that they are interacting with the business during an ATM/kiosk transaction. The business 14 may obtain data regarding the transaction(s) occurring at the ATM/kiosk via the network 38. In the case of an interactive kiosk, however, there may be direct interaction between the business and the kiosk 28 in order to provide various choices to the consumer 12 via the kiosk 28. In all cases, interaction data is stored by the business 14 in the interaction history database 48.

The consumer 12 may also interact with the business 14 via a self-service check-out 30. The interaction between the consumer 12 and the business with regard to the self-service check-out 30 may occur in the background of the transaction and not immediately apparent to the consumer 12. Stated another way, the consumer is typically not cognizant that they are interacting with the business during a self-service transaction. The business 14 may obtain data regarding the transaction(s) occurring at the self-service check-out 30 via the network 40. In the case of an interactive self-service check-out, however, there may be direct interaction between the business and the self-service check-out 30 in order to provide various choices to the consumer 12 via the self-service check-out 30. In all cases, interaction data is stored by the business 14 in the interaction history database 48.

An other input block 58 in communication with the business processing unit 44 represents the receipt of interaction data from other interactions and/or sources not specifically mentioned or shown herein. This interaction data is stored in the interaction history database 48.

The business 14 thus stores data relating to consumer interactions both directly with the business 14 and indirectly with the business 14 (interaction data), as well as data pertaining to interactions between the business and the consumer initiated by the business. This interaction data forms an interaction history for a particular consumer that is accessible by the business 14 and, in certain circumstances, by the consumer 12. In accordance with an aspect of the present invention, the business 14 uses the consumer interaction history 48 to ascertain and establish a context of a current or future consumer interaction where and when necessary.

Thus, in addition to obtaining and storing interaction data, the business 14 accesses and utilizes the interaction history database 48 to establish a context of a consumer's current interaction with the business. The historical interaction data from the interaction history database 48 is processed to allow the business to ascertain and view various information, preferences and the like regarding the consumer and the business. In particular, the historical data is processed by the processor 50 when queried by the business to provide the business with processed historical data to determine a context of the current consumer interaction.

The general manner in which the business 14 carries out the above will be described in connection with FIG. 3. Referring now to FIG. 3, there is depicted a flow chart, generally designated 60, of the general operation of the system 20. Initially, the business 14 obtains or garners data consumer/business interactions (interaction history) from every consumer/business interaction, block 62. Thus every time a consumer interacts with the business, or the business interacts with the consumer, the business accumulates data therefrom. The obtained interaction data is then stored in the interaction database 48 (see FIG. 1), block 64. It should be appreciated that blocks 62 and 64 represent a historical process for the business. Sufficient interaction data must typically be obtained by the business so that a context of a current interaction may be established.

Thus, assuming that there is sufficient historical interaction data in the interaction database 48, the business receives a current interaction, block 66. The current consumer/business interaction is typically in the context of the consumer invoking the interaction, as set forth above in connection with FIG. 1. However, it should be appreciated that the business may invoke the interaction. The business then accesses the interaction history database 48, block 68. Accessing the interaction history database 48 may involve processing the historical interaction data in order to cull the necessary information from the historical data. The software 50 thus aids in determining a context of the current consumer interaction, block 70, for the business, in order to facilitate the exchange between the business and the consumer. Once a context is determined by the software 50, the business uses this information in real time during the interaction. Thus, a consumer's interaction history with a business can be used as a means to rapidly establish a context between the consumer and the business.

The interaction history database 48 may record information about interactions between a customer and a business pertaining to a positive act by either party, such as “bill mailed”, “product purchased over Internet”, “customer telephoned regarding . . . ”, etc. Additionally, the business 14 (i.e. the system) may also access, sort, and/or process the historical interaction data each time a consumer interacts with the business (such as a customer calling into a business or visiting their web site). The historical interaction data may also be presented to the consumer during a consumer interaction, in a way that is “actionable” (i.e. such as clicking on a “bill mailed” icon or the like to launch into a billing application for that bill, or clicking on a “product purchased” icon or the like to retrieve Frequency Asked Questions about the product).

The present system and method allows a business (e.g. call center 52, Internet site 54 or the like) to access a list of bills that have recently been sent to the consumer (i.e. historical interaction data from the historical interaction database 48). The call center 52 may thus use the historical interaction data to rapidly locate the bill in question from the list and immediately begin addressing the consumer's concern. The call center 52, via the historical interaction database 48, allows the business 14 to know purchase information for the consumer. If the consumer inquires regarding the product, the business 14 can ascertain the exact product purchased and thus direct the telephone call to an agent knowledgeable about the problem or to an Internet (web) site that contains information about the product in question.

In this regard, the business can automatically access and sort historical interaction information related to the consumer when that consumer initiates a new interaction. Further, the historical interaction database 48 contains historical interaction data that contains locations of the interaction device used by the consumer, such as the location of the ATM or kiosk that was used so that the business 14 can gain an immediate context of which machine caused the problem. In these instances, the business can ascertain the context of the customer's interaction based on the historical interaction data and any additional information provided by the consumer during the current interaction.

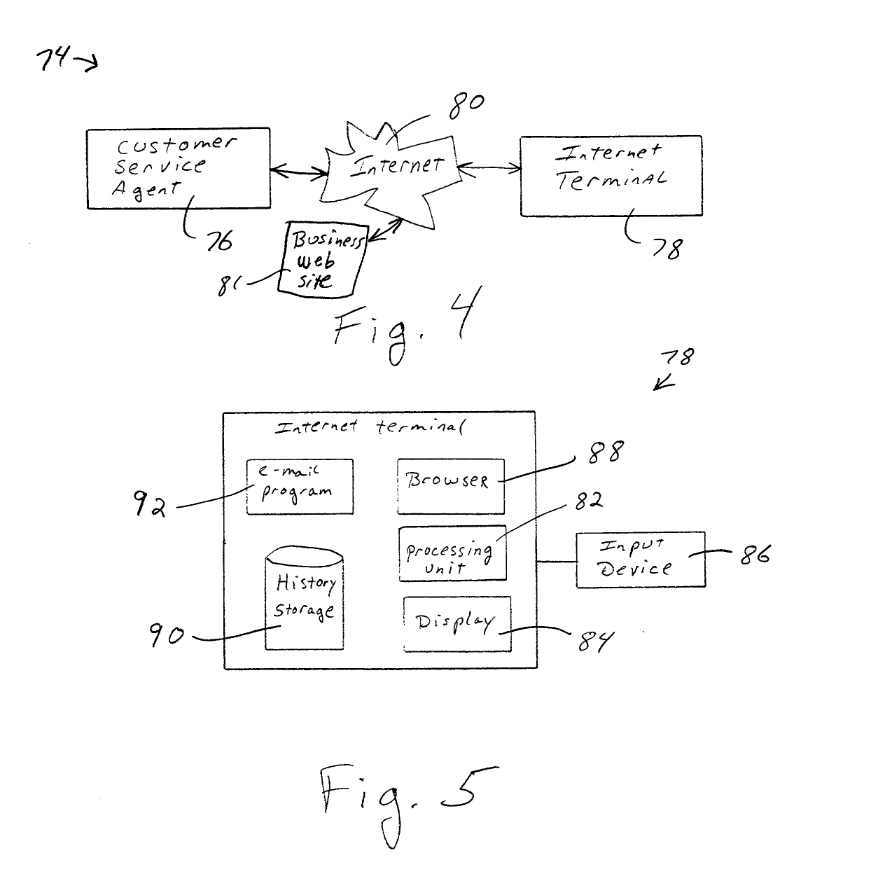

Referring to FIG. 4, there is depicted a block diagram, generally designated 74, representing a particular manner in which a consumer may interact with a business. In this scenario, the consumer has access to an Internet terminal 78 or any device suitable for use with the Internet 80. The business is represented by a customer service agent 76 or operator. The customer service agent 76 is connected to the Internet 80 via appropriate hardware and software to receive and send e-mails such as is depicted in FIG. 2. The customer service agent 76 also preferably has access to the business web site 81 or a facsimile thereof.

The consumer uses the Internet terminal 78 to access and browse the business web site 81 in a known manner. The business web site 81 includes an e-mail link, icon or the like that allows the consumer to compose an e-mail to forward to the customer service agent 76 (i.e. business). The e-mail forms an interaction (consumer to business interaction) with the Internet being the access channel. Selection of the e-mail link from the business web site 81 by the consumer causes the Internet terminal 78 to invoke and run an e-mail program on the Internet terminal 78 and appropriately address an e-mail to the business. In accordance with an aspect of the present invention, text or other data (“text”) is automatically attached, appended, and/or entered into the e-mail message for use by the customer service agent 76 (i.e. business).

The text that is automatically inserted into the e-mail includes information regarding the user/consumer (e.g. user identification information and/or the like) and at least some portion of the user's recent and/or current Internet session history regarding the business web site 81. The information regarding the Internet session history without being exhaustive, may include the various web pages visited, the order of viewing of the web pages, what was accessed from the various web pages, messages received during viewing, etc. The information may be encrypted, encoded or the like. The user/consumer is also allowed to insert text or other information into the e-mail. The e-mail may pertain to a question, an order, or the like.

The e-mail is then sent to the customer service agent 76 via the Internet 80 in a known manner through the e-mail program. The customer service agent 76 receives the e-mail with the automatically inserted text. The automatically inserted text is preferably coded to allow the customer service agent 76 to be able to view and use the text. Based on the text, the customer service agent 76 is then able to retrieve more information regarding the consumer from the interaction history database 48 in response to the identification information in the e-mail. As well, the customer service agent 76 is able to review the web session history of the customer. In this manner, the customer service agent 76 is able to ascertain a context in which the e-mail was generated and sent, and then aid in resolving any problems. The context of the e-mail may be established by the business software. This may be accomplished in one form by having the automatically inserted coding of the e-mail invoke a program or programs at the business to read the text and automatically retrieve more information from the interaction history database 48 and also perform other various functions.

With reference to FIG. 5, various components of the Internet terminal 78 that aid in the automatic insertion of identifying text, coding and other data, into a consumer's e-mail are shown in greater detail. The Internet terminal 78 includes a typical processing unit 82, a display 84, and an input device 86. The processing unit 82 is operable to run a typical Internet browser program 88 as well as an e-mail program 92. The browser program is operable to access the Internet 80, view and utilize web sites on the Internet 80 including the business web site 81.

The Internet terminal 78 further includes a storage device 90 that is adapted to retain Internet session history data. In one form, the Internet terminal 78 includes programming (such as a plug-in for the browser 88 or the like) to acquire and retain Internet session history data on the storage device 90. Alternatively, the Internet terminal programming may cause the Internet session history data to be retained on a storage device of the business. In another form, the business web site 81 (or the business in general) includes programming to acquire and retain Internet session history data for user's accessing the business web site 81. In any case, selecting the e-mail link from the business web site 81 causes Internet session history, a synopsis thereof, or other identifying means regarding the Internet session history, to either be inserted into the e-mail (such as when the Internet session history is stored on the Internet terminal 78) or by coding identifying the particular Internet session history (such as when the Internet session history is stored by the business) in addition to other data as explained herein.

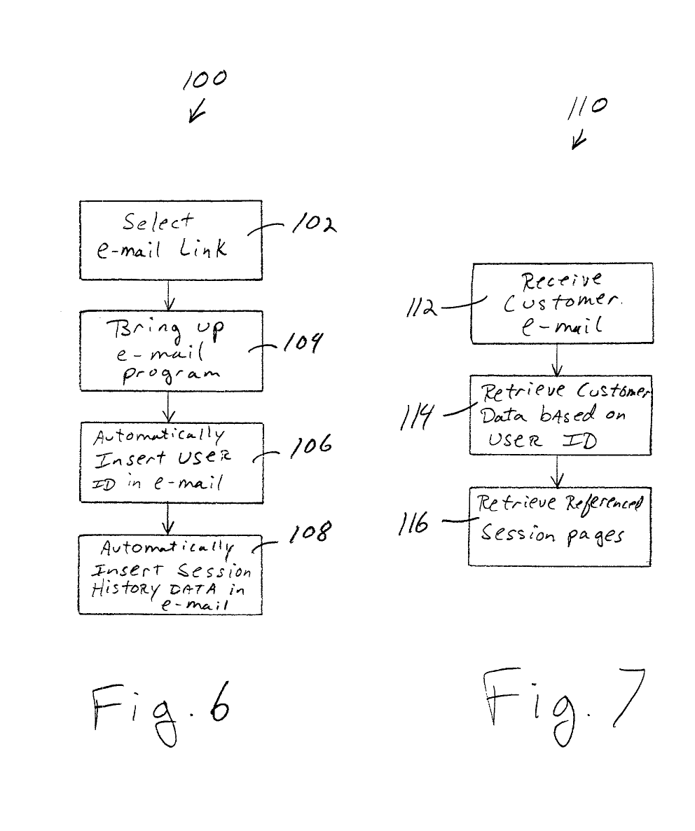

Referring to FIG. 6, there is shown a flowchart, generally designated 100, depicting the consumer's actions in invoking an interaction as specifically set forth above with reference to FIGS. 4 and 5. The consumer, while viewing the business web site, selects the e-mail link/icon on the business web site, block 102. Selection of the e-mail link causes the Internet terminal 78 of the consumer to invoke its e-mail program, block 104. The selection of the e-mail link also causes user identification data or information (customer data) to be automatically added to the e-mail, block 106. In one form, the user identification data may be generated and/or obtained by the business web site and stored by the business web site or on the Internet terminal 78. In another form, the user identification data is generated, obtained, or retrieve by the Internet terminal 78. Thereafter, session history data is also added to the e-mail, block 108.

Referring to FIG. 7, there is shown a flowchart, generally designated 110, depicting the business' actions in receiving the e-mail interaction, above, sent by the consumer. The customer service agent 76 receives the e-mail, block 112. The customer data is retrieved based on data within the e-mail, block 114. Thereafter, the Internet session history for the identified customer is retrieved, block 116. In this manner, the customer service agent 76 can view the message that the customer has inserted into the e-mail, identify the customer and thus view any data regarding the customer that the business has in its database, and see the Internet session history, in whatever form, of the customer to gain a whole understanding of the context of the customer's interaction.

While this invention has been described as having a preferred design and/or configuration, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of establishing a context of an interaction between a consumer and a business comprising the steps of:
storing historical interaction data between a consumer and a business, the historical interaction data regarding interactions between the business and the consumer;
receiving a communication from the consumer;
accessing historical interaction data regarding the consumer; and
processing the historical interaction data regarding the consumer in view of the received communication from the consumer to establish a context of the received communication from the consumer.

2. The method of claim 1, wherein the communication from the consumer is received via any one of a plurality of access channels.

3. The method of claim 1, further comprising the step of:
obtaining interaction data from previous consumer to business interactions; and
the step of storing historical interaction data between a consumer and a business includes storing the interaction data from the previous consumer to business interactions in the historical interaction database.

4. The method of claim 1, further comprising the step of:
presenting the historical interaction data to the consumer.

5. The method of claim 4, wherein the step of presenting the historical interaction data to the consumer includes providing the historical interaction data to the consumer in a consumer actionable format.

6. The method of claim 1, wherein the communication from the consumer includes auxiliary data.

7. The method of claim 6, wherein the auxiliary data includes consumer identification data.

8. A method of interaction between a business and a consumer comprising the steps of:
maintaining a database of past interaction data from previous consumer to business interactions;
receiving an interaction initiation from a consumer;
accessing past interaction data regarding the consumer from the database of past interaction data,
processing selective past interaction data regarding the consumer in view of the interaction initiation; and;
establishing a context of the interaction initiation based on the processed past interaction data regarding the consumer and the interaction initiation.

9. The method of claim 8, wherein the interaction initiation is received via any one of a plurality of access channels.

10. The method of claim 8, further comprising the steps of:
obtaining interaction data from previous consumer to business interactions; and
the step of maintaining past interaction data includes storing the interaction data from the previous consumer to business communications and interactions in the past interaction database.

11. The method of claim 1, further comprising the step of:
presenting the processed past interaction data to the consumer.

12. The method of claim 11, wherein the step of presenting the processed past interaction data to the consumer includes providing the processed past interaction data to the consumer in a consumer actionable format.

13. A method of establishing context of an e-mail from a consumer to a business regarding an Internet site of the business, the method comprising the steps of:
receiving an e-mail originating from an Internet terminal of a consumer, the e-mail having consumer identification data and consumer Internet session history data regarding an Internet site of the business;
accessing stored historical interaction data regarding the consumer based on the customer identification data;
reviewing the customer Internet session history data; and
determining a context in which to present a response to the e-mail based on the customer identification data, the customer Internet session history data, and the e-mail.

14. The method of claim 13, further comprising the step of:
producing a response to the e-mail based on the determined context.

15. The method of claim 13, further comprising the following step before the step of receiving an e-mail from a customer:
automatically generating a template e-mail on the Internet terminal of the consumer upon the consumer selecting an e-mail link on the business Internet site, the template e-mail including the customer identification data and the customer Internet session history.

16. The method to claim 15, further comprising the step of:
automatically invoking an e-mail program on the Internet terminal of the consumer in response to the consumer selecting the e-mail link on the business Internet site and providing the template e-mail to the e-mail program.

17. The method of claim 13, further comprising the steps of:
obtaining interaction data from previous consumer to business interactions; and
storing the interaction data from the previous consumer to business interactions in a historical interaction database.

18. An apparatus for establishing a context of an interaction between a consumer and a business comprising:
a data storage adapted to retain historical consumer to business interaction data regarding a consumer;
means for receiving a communication from the consumer; and
a processing unit adapted to i) access the historical interaction data regarding the consumer upon receipt of the communication from the consumer, and ii) process selective historical interaction data regarding the consumer in view of the received communication from the consumer to establish a context of the received communication from the consumer.

19. The apparatus of claim 18, further comprising:
means for providing a response to the communication from the consumer based on the established context of the received communication from the consumer.

20. The apparatus of claim 18, wherein the means for receiving a communication from the consumer is operable to receive the communication from the consumer from any one of a plurality of access channels.
